(19) United States
(12) Patent Application Publication
(10) Pub. No.: US 2009/0018952 A1
(43) Pub. Date: Jan. 15, 2009

(54) SYSTEM AND METHOD FOR PROSPECTING AND PROCESSING LOAN APPLICATIONS

(76) Inventors: Gabriel P. Beltran, Dublin, CA (US); Elisabeth Beltran, Dublin, CA (US); Jesus A. Orosco, Fremont, CA (US); Stanley T. Stadelman, JR., Castro Valley, CA (US)

Correspondence Address: SHEPPARD, MULLIN, RICHTER & HAMPTON LLP, 333 SOUTH HOPE STREET, 48TH FLOOR, LOS ANGELES, CA, 90071-1448, US

(21) Appl. No.: 11/777,236

(22) Filed: Jul. 12, 2007

(51) Int. Cl. G06Q 40/00; G06F 17/30

(52) U.S. Cl. 705/38

(57) ABSTRACT

The present invention provides a method for loan prospecting that comprises retrieving a telephone number of a potential client from a first database using a client relation management (CRM) module, calling the retrieved telephone number to determine whether the potential client is interested in a financial product using a dialer embedded on a graphical user interface (GUI) of the CRM module, retrieving personal data on the potential client from one or more external databases if the personal data is not available in the first database, displaying the retrieved personal data on the GUI, verifying the potential client's identity using the personal data, obtaining a credit score on the potential client, generating a loan pricing report using one or more pricing engines based on the credit score and the personal data, and displaying the loan pricing report on the GUI.

### TECHNICAL FIELD

The present invention relates to loan processing, and more particularly, systems and methods for loan prospecting and processing.

### DESCRIPTION OF THE RELATED ART

Conventional loan prospecting methods require loan officers to manually make cold call to potential clients. Typically, calls are made to the potential client's home telephone number, which may be obtained at various public databases or at a county's recorder office. Most cold calls result in lack of interest and provide no additional lead. This manual cold calling process is very burdensome, inefficient, and costly to the loan provider.

Even when a cold call results in a lead, conventional loan soliciting and processing methods remain inefficient due to the manual aspect of data gathering and processing. For example, once a potential client is identified, the loan officer must ask the potential client series of personal and financial information, including information that may be publicly available. The collected information must then be manually entered into a database by the loan officer.

The next step in the loan process is to generate various types of reports such as credit history, housing information, market analysis, and other loan related reports. Loan officers generate these types of reports based on the collected information using a variety of disparate tools. This conventional approach to loan processing is inefficient because there is a lack of automation and a lack of cooperation and integration among of the plurality of tools used. The conventional approach is also prone to human errors because data are entered manually, and often times the loan officer is required to enter the same data repeatedly because multiple tools may require the same data.

### BRIEF SUMMARY OF EMBODIMENTS OF THE INVENTION

According to various embodiments of the invention, systems and methods for loan prospecting and processing are provided. In accordance with one embodiment of the invention, a method of loan prospecting and processing includes the steps of: retrieving a telephone number of a potential client from a first database using a client relation management (CRM) module; calling the retrieved telephone number to determine whether the potential client is interested in a financial product using a dialer embedded on a graphical user interface (GUI) of the CRM module; retrieving personal data on the potential client from one or more external databases if the personal data is not available in the first database; displaying the retrieved personal data on the GUI; verifying the potential client's identity using the personal data; obtaining a credit score on the potential client from the client or internal or external databases or services; and generating a loan pricing report using one or more pricing engines based on the credit score and the personal data. Personal data comprises one or more of the following data types: address information, property type, value of property, social security number, and date of birth. In an embodiment, a loan-to-value is determined using one or more of the datum points of the personal data.

The method for loan prospecting and processing may further include the steps of: obtaining an automated valuation model from a third-party provider using one or more datum points of the personal data; prompting the potential client to enter the client's social security number if it is not available in any proprietary or third-party databases. The social security number is used to obtain the client's credit score. In an embodiment, the credit score is obtained from one or more credit bureaus such as Experian, Equifax, and TransUnion, directly or through a third-party integrator. In yet another embodiment, wherein the credit score used is a median credit score among the credit scores from the three different credit bureaus.

In an embodiment of the invention, the loan pricing report is generated using one or more third-party pricing engines. Once the report is generated, the potential client is informed on the result via a telephone call, mobile text, or electronic mail, and the results of the report are saved to the CRM database 230.

Other features and aspects of the invention will become apparent from the following detailed description, taken in conjunction with the accompanying drawings, which illustrate, by way of example, the features in accordance with embodiments of the invention. The summary is not intended to limit the scope of the invention, which is defined solely by the claims attached hereto.

### BRIEF DESCRIPTION OF THE DRAWINGS

The present invention, in accordance with one or more various embodiments, is described in detail with reference to the following figures. The drawings are provided for purposes of illustration only and merely depict typical or example embodiments of the invention. These drawings are provided to facilitate the reader's understanding of the invention and shall not be considered limiting of the breadth, scope, or applicability of the invention. It should be noted that for clarity and ease of illustration these drawings are not necessarily made to scale.

FIG. 1 is a diagram illustrating an exemplary environment in which the present invention can be implemented.

FIG. 2 is a diagram illustrating a Client Relationship Management Portal according to an embodiment of the present invention.

FIG. 3 is an operational flow diagram illustrating a process for prospecting and processing a loan according to an embodiment of the present invention.

The figures are not intended to be exhaustive or to limit the invention to the precise form disclosed. It should be understood that the invention can be practiced with modification and alteration, and that the invention be limited only by the claims and the equivalents thereof.

### DETAILED DESCRIPTION OF THE EMBODIMENTS OF THE INVENTION

1. Overview

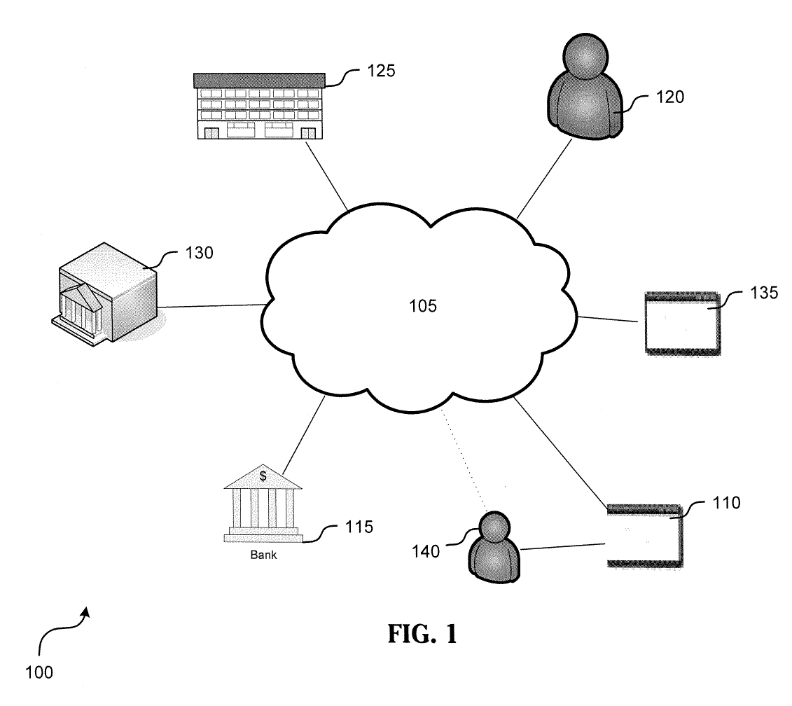

Before describing the invention in detail, it is useful to describe an example environment with which the invention can be implemented. FIG. 1 illustrates an environment 100 that includes a network 105, a client relationship management (CRM) module 110, a bank 115, a user or potential client 120, a credit bureau or agency 125, a local agency 130, and a stand-alone application(s) or service(s) 135. Network 105 can be the internet, a local area network (LAN), a wide area network (WAN), a plain old telephone system (POTS), or any other suitable networks. As shown, CRM module 110 is coupled to network 105. This enables CRM module 110 to communicate with bank 115, user 120, credit bureau 125, local agency or agencies 130, and with stand-alone applications 135, all of which are also coupled to network 105. It should be noted that CRM module 110, bank 115, user 120, credit bureau 125, and local agency 130 may connect to network 105 using various means such as via a wireless network and/or phone line. Similarly, stand-alone application 135 may be connected to CRM module 110 via a LAN or a wireless LAN network.

As used herein, the term “module” is used to describe a given unit of functionality that can be performed in accordance with one or more embodiments of the present invention. As used herein, a module can be implemented utilizing any form of hardware, software, or a combination thereof. In implementation, the various modules described herein can be implemented as discrete modules or the functions and features described can be shared in part or in total among one or more modules. In other words, as would be apparent to one of ordinary skill in the art after reading this description, the various features and functionality described herein may be implemented in any given application can be implemented in one or more separate or shared modules in various combinations and permutations. Even though various features or elements of functionality may be individually described or claimed as separate modules, one of ordinary skill in the art will understand that these features and functionality can be shared among one or more common software and hardware elements, and such description shall not require or imply that separate hardware or software components are used to implement such features or functionality.

On a high level, CRM module 110 makes the loan soliciting and processing process more efficient by automating the communication with user 120 and with various public and private databases to compile necessary information for a loan application. CRM module 110 is also configured to work with various stand-alone applications or services such as pricing services offered by New York Loan Exchange (NYLX) or by Calyx Software, Inc., a California corporation, to generate various loan related reports. CRM module 110 provides an integrated environment that allows the loan officer to consolidate data and functionalities of these databases and services in order to provide a total mortgage solution to user 120. According to a preferred implementation, the various modules of the invention comprise software modules, residing on a server, comprising machine-readable or interpretable instructions for loan prospecting and processing.

In an embodiment, CRM module 110 automatically makes phone call to user 120, which may be a randomly selected from a phone database. Through a voice recognition algorithm, CRM module 110 may determine whether the call is connected, and if connected, whether the call is connected to a fax machine, answering machine, or user 120, and CRM module 110 may use this determination to prioritize transferring the call to Loan Officer 140. In an alternate embodiment, CRM module 110 may not transfer the call 157 until some data verification or indication of customer interest has occurred. CRM module 110 may determine this by prompting user 120 to press 1 if user 120 is interested, for example. CRM module 110 ends the telephone call if user 120 is not interested. If the user is interested, CRM module 110 may transfer user 120 to a loan officer where further processing can take place or automatically perform additional tasks such as address and identity verification prior to transferring user 120. In a preferred embodiment, CRM module 110 utilizes the interpersonal interactions and inputs of Loan Officer 140 with and in regards to user 120 verify the user address and obtain various personal data such as social security number and date of birth, for example. Verification of the user address is accomplished by first querying public and/or private databases such as databases at various local government agencies (e.g., a county land recorder office database). Address information retrieved from one or more of these databases is stored and is later recited to user 120 for verification. If the address information cannot be located, then CRM module 110 prompts user 120 to input the user address.

In an alternate embodiment, CRM module 110 may automatically record and systematize the user input with voice recognition software. Alternatively, CRM module 110 may transfer user 120 to a loan officer to request user input and enter the collected information into a database. This automation functionality of CRM module 110 allows it to scale the number of outbound lines opened per available Loan Officer 140, or in embodiments which rely upon automated inputs or inputs by user 120, maximize the number of outbound lines opened. In this way, CRM module 110 can quickly and efficiently screen potential clients.

Once the user address is verified, CRM module 110 queries various public and private databases such as the land recorder databases or other private databases for various information on the user property. CRM module 110 may query one or more of those databases for information such as: the user property lot size, square footage, fair market value, mortgaged amount, secondary mortgage if any, neighborhood sales statistics, etc. Once these data are collected, CRM module 110 stores them along with the user identification for future use.

Additionally, prior to performing the queries above, CRM module 110 may ask user 120 whether the user 120 is a renter-occupant. If the user 120 is a renter-occupant, CRM module can skip the property investigation step.

In an alternate embodiment, most of the data collection step is automatically performed by CRM module 110. It is recognized that user 120 may not wish to work with an automated system or user 120 may grow weary and impatient during the automated process. Thus, in an embodiment, CRM module 110 provides user 120 with an option to speak to a live loan officer at any point during the automated process. This may be accomplished by instructing user 120 to press a series of special keys such as #8, for example, whenever user 120 wishes to be transferred to a live loan officer. In this way, the risk of loosing a potential client is reduced. Further, at a certain point in the loan process, it is preferable that the loan officer 140 interview user 120 for additional information such as financial and employment status. The collected financial and employment data may include, but not limited to, income, duration at job, name of employer, position title, etc.

During the automated information collection process, CRM module 110 requests for the user social security number (SSN). The user SSN is necessary for obtaining the user credit history, which is essential in determining what types of loan and interest rate user 120 is qualified to obtain. User 120 may enter her SSN using the numeric keypad on the telephone. As mentioned, CRM module 110 is also equipped with a voice recognition system. Thus, user 120 may also input the SSN verbally. As another alternative, CRM module 110 may transfer user 120 to the loan officer 140 where user 120 may directly interact with the loan officer 140.

In an embodiment, CRM Module 110 uses the social security number to retrieve a credit score or report from one of the three credit bureaus (i.e., Experian Equifax, and TransUnion). Alternatively, CRM module 110 may use the median, average, minimum, or maximum credit score among the scores provided by those bureaus. In an embodiment, CRM module 110 uses the social security number to pull a merged credit report from one or more credit bureaus. Once this report is received, CRM module 110 stores the report under the user file or identity for later retrieval and use.

CRM module 110 also provides user 120 with an option to estimate her credit rating. Although this would yield a less accurate loan pricing report, user 120 may nevertheless select this option because she does not wish to release her social security number.

Once the user credit score is established or estimated, CRM module 110 compiles all available data (e.g., type of residence, FMV of residence, income) on user 120 and forwards all relevant data to a pricing engine, such as one provided by NYLX, in order to generate a loan pricing report.

CRM module 110 is also configured to work with mortgage reporting and origination software such as Calyx Point®, by Calyx Software, or Encompass®, by Ellie Mae. Once the load pricing report is generated, CRM module 110 automatically forwards all relevant data, including the loan pricing report, to one or more of the mortgage reporting and origination softwares. In this way, the loan officer may at her own choosing generate all of the required Federal and State disclosures all within CRM module's 110 user interface. This automation process allows the loan officer to avoid using a plurality of disparate programs which often add confusion and complexity to the entire loan generation process.

2. Client Relationship Management

2.1 CRM Portal

CRM module 110 is a web-hosted application or portal that includes various functions or software modules such as a dialer, an interest rate tracker, client information database, a pricing engine, and training module. The functionality of each module will be described below. CRM module 110 may be accessed using a secured hypertext transfer protocol (HTTPs), which requires a username and password for access. Parties that will be using CRM module 110 includes, but not limited to, loan officer, real estate or loan agents, brokers, correspondents, telemarketers, processors, and underwriters, herein collectively referred to as loan officer. As mentioned above, CRM module 110 may be accessed via a local area network, a wide area network, or a wireless network. CRM module 110 may be a web-based application or a stand-alone desktop application operable in various operating systems such as Windows®, MAC OS, LINUX, and other suitable operating systems, or Rich Internet Application (RIA).

CRM module 110 stores all data relating to a loan transaction into a database. All data stored on CRM database 230 are collected using one or more of the following methods: batch import, specific query import, manual entry, web-based form, dial tone, or voice recognition. CRM database 230 may store all forms of data pertaining to the loan transaction. The types of data CRM database 230 can store include, without limitation: Adobe (PDF) documents, Microsoft Office documents, XML query responses, credit reports, Calyx Point files, Fannie Mae files, Ellie Mae files, bitmaps, jpegs, etc.

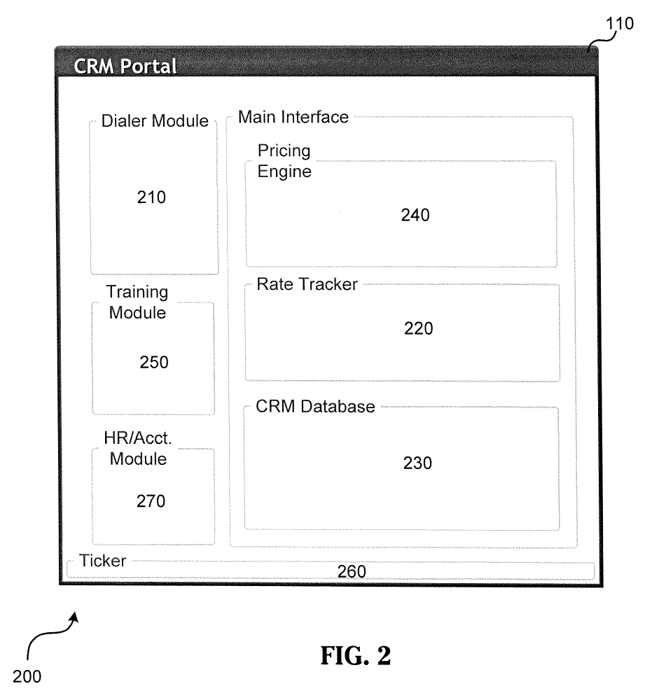

The main function of CRM module 110 is not only to collect data but also to integrate various mortgage tools to provide a total mortgage solution within a single application. CRM module 110 aims to eliminate the need for the loan officer to be an expert with the operation, format, and protocol of other mortgage programs such as NYLX, Calyx Point, and Encompass. This is accomplished by consolidating the collected data, transforming relevant data into proper format and protocol, and finally transfer them to the appropriate mortgage tools as configuration data, raw data, or commands. The total mortgage solution provided by CRM module 110 starts with the graphical user interface (GUI) or portal 200, as shown in FIG. 2.

Portal 200 includes a dialer module 210, an interest rate tracker 220, a client information database 230, a pricing engine 240, and a training module 250. Dialer module 210 is a predictive, progressive, and a power dialer application. Dialer module 210 permits outbound telemarketing through analog (POTS) or voice-over-internet-protocol (VoIP) services, through-‘single-click’ dialing, or quasi-sequentially, through user-defined lists, or sub-sets of the total CRM database 230. These lists are generally called ‘campaigns’. Dialer module 210 includes a function called “campaign wizard.” This function allows dialer module 210 to filter data sets in CRM database 230 to create custom lists (‘campaigns’) of telephone numbers to be dialed or queued. CRM module 110 and dialer module 210 are integrated, such that any changes to data in CRM database 230 will be automatically updated in the campaigns list generated by the campaign wizard. The campaign wizard also includes an integrated interface with one or more third-party data sources, including, but not exclusive to: DataQuick®, a product of DataQuick Information System, which is a subsidiary of MacDonald, Dettwiler and Associates, LTD, a Canadian company; SiteXData®, a product of Fidelity National Data Services, which is a division of Fidelity National Financial, Inc., a Florida corporation; and Leads-to-Loans®. Dialer module 210 may download data from the third-party databases directly into CRM database 230.

As mentioned, CRM database 230 and dialer module 210 are fully integrated. This means downloaded data will be immediately available for use by the campaign wizard to update current or create new campaign. Dialer module 210 also allows the user to save the filter criteria submitted to these third-party data-providers and schedule automatic future data requests (e.g. on a monthly basis).

When actively cycling through campaigns, dialer module 210 manages the dialing and connection process independent of user-input, and, after algorithmically verifying a connection, will route the connection to the next available loan officer. The user interface of dialer module 210 will also display all available data associated with the particular ‘lead’, including, but not limited to, personal information (name, address, employment, social security number, date of birth, credit history, spousal/co-borrower personal information), mortgage information (lender, loan amount, date, property, loan type, loan rate, pre-pay duration, impound specifics), property information, (year built, taxes, rooms, square footage, pool, zoning). Data on a particular lead may be previously stored in CRM database 230 or are obtained in real-time while the potential client is on hold or in queue for the next available loan officer 140, or directly by loan officer 140. As mentioned, CRM module 110 collects data on the potential client by querying the potential client and by searching through various private and local databases.

Dialer module 210 will also display a third-party AVM (automated valuation modeling) data. AVM data may be obtained from various valuation services such as Landsafe, DataQuick, SiteXData, or Zillow.com. CRM module 110 is configured to automatically determine all of the data needed by the pricing engine and retrieve those data from CRM database 230 for forwarding to the pricing engine. This feature allows the loan officer to be more efficient and also reduces errors in the loan application process.

AVM is an algorithmic estimate of property value derived from sales of comparable property, market trends and expectations for a specific property (i.e., the potential client's property). Per fulfillment of some criteria, AVM report may be used in place of a formal appraisal, and may be submitted to the wholesale lender and/or secondary market purchaser/auditor as the primary property-value documentation. AVM is not required for all potential clients (e.g., if a formal appraisal has already been completed). Thus, CRM module 110 gives the user 120 or loan officer 140 the option of whether or not to obtain an AVM. Further, prior to requesting the third-party AVM, CRM module 110 may prompt or remind the loan officer to obtain the potential client's approval of the third-party provider.

Dialer module 210 uses the AVM data along with all available data on the potential client to calculate an estimated Loan-to-Value and Combined-Loan-to-Value (LTV and CLTV) percentage. The loan officer may establish a “trigger LTV”, the term for a pre-set value which will automatically disposition a lead based on estimated LTV or CLTV. This disposition may be saved by data bit in CRM module 110 for filtering purposes. The loan officer may execute a one-click pricing scenario from the active UI while dialing, utilizing the Pricing Engine. This one-click process executes the same “disposition to submission” process discussed under the ‘CRM’ heading, with all associated data being saved to CRM database 230.

Dialer module 210 is configured to schedule and execute calls to specific numbers and route those connections to pre-designated Loan Officer 140, using an embedded scheduling function. The function is automatically configured to postpone calls if either party is unavailable to the next similar time (i.e. 24 hours post-dated).

As described above, CRM module 110 is configured to use one or more pricing engine module 240 to obtain various loan related reports/statistics such as rates, APR, YSP (yield spread premium, also known as ‘rebate’), payments, and margins. CRM module 110 provides all of the necessary data (e.g., credit reports and AVM data) on the potential client or user 120 to pricing engine 240 automatically. In this way, the entire loan process is quicker and less prone to errors. All results/data received from the pricing engine are stored on CRM database 230 along with user 120 identifier. In this way, CRM module 110 will be able to quickly retrieve all available data for user 120 in the future.

Pricing engine module 240 is also configured to generate various reports and forms for submission to various private and governmental entities. Among the reports and forms generated are, but not exclusive to: Good Faith Estimate (GFE), Truth-In-Lending (TIL) disclosures, borrower's authorization and certification form, etc. Using pricing engine module 240, the loan officer may also execute a ‘lock’, putting a hold on warehouse funds for the purposes of the specific transaction. The loan officer may also monitor unlocked pricing results through the rate tracker module 220.

Rate tracker module 220 includes a user interface (UI) that displays a list the loan officer's active submissions or monitored files, and corresponding pricing information including, but not exclusive to: ‘loan amount’, ‘loan type’, ‘rate’, and ‘price/rebate’. The loan officer may also toggle between different display formats such as a ‘wholesale pricing’ format (e.g., 101.490), or ‘retail rebate’ format (e.g., −1.490). Pricing results managed by the rate tracker module 220 may be automatically updated from remote XML or other real-time source, according to default or user-defined scheduling.

Rate tracker module 220 also allows the loan officer to execute a ‘lock’ directly from the rate tracker module 220 by means of ‘point-and-click’, or they may pre-set a desired rate, price/rebate, or combination thereof, where-after the rate tracker module 220 will enact a lock when the conditions are met. Engaging a ‘lock’ will activate the nested e-mail or electronic-transmission application to send notifications via email, cellular text, instant-message, or phone call to pre-defined parties.

For example, the loan officer may customize a loan product by locking the loan product to a specific loan variables such as loan type, loan amount, rate, and price and/or rebate. Once this is completed, the newly created loan product may be stored along with the customer's identification for later retrieval. In an embodiment, the loan variables of the loan product may be changed by the loan officer or by the potential client.

To ensure that the loan product contains the latest information such as rate and cost, rate tracker module 220 or CRM module 110 may automatically query third-party pricing databases at various time intervals for updated information. Further, results from the query is compared with a desired set of pricing criteria. As a further, safeguard, the comparison is verified to determine it meets a predefined standard. Once the comparison and verification process is completed, the loan product may be permanently locked.

CRM module 110 aims to simplify the loan application process by consolidating various functions such as clients prospecting, data gathering, market analysis, and report generation. CRM module 110 accomplishes this by employing a bi-directional integration with stand-alone or common-component LOS's, namely, but not exclusive to, Calyx Point® and Encompass®. CRM module 110 is configured to work LOS to perform various function such as: input of data pertaining to loan-submissions; production of standardized or proprietary loan documents, disclosures, application materials, and reports. The CRM application (CRM module 110) is designed to integrate various applications and functions from several disparate stand-alone tools. The processes executed by third-party LOS may be completed in part or in full by CRM module 110. Articles produced by third-party LOS or by CRM module 110 are stored in CRM database 230. These articles are retrievable using CRM module 110 interface. CRM module 110 can also convert the stored articles into various formats for viewing and/or manipulation.

In an embodiment, CRM module 110 is configured to inform the loan officer on various secondary mortgage market instruments and/or products available using a popup window (not shown) or an advertisement portion or ticker 260. In this way, the loan officer may ask user 120 whether she is interested in any of the secondary mortgage market products. In an embodiment, CRM module 110 may automatically query user 120 to determine whether there is an interest in any one of the secondary mortgage products such as, but not limited to, mortgage backed securities, collateralized mortgage obligations, real estate investment trusts, real estate mortgage investment conduit, or any other ‘non-agency’ secondary mortgage market instrument. If user 120 is interested in any of these products, CRM module 110 will automatically gather all of the required information on user 120 from CRM database 230 and forward it to a provider (e.g., a bank). Using the received information on user 120, the provider may qualify user 120 for hidden programs. These programs may be highly-exclusive, developmental, proprietary, confidential, and may be hidden from the loan officer.

2.2 CRM Process Flow

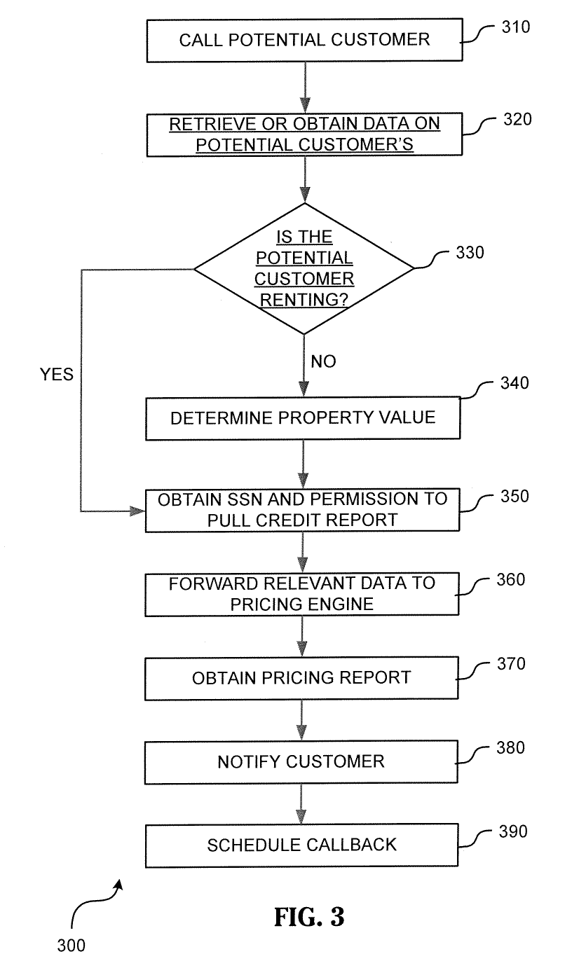

FIG. 3 illustrates a flow diagram of a method 300 implemented by CRM module 110 for prospecting and processing one or more loan application. In step 310, dialer module 210 makes one or more phone call to perspective client or user 120. Dialer module 210 first obtains a list of phone numbers from CRM database 230. This list may be created by the loan officer using the campaign wizard, which is part of dialer module 210 as previously described above.

In step 320, using each phone number as a reference, CRM module 110 attempts to gather all available information for each of the phone numbers on the list from one or more public and/or private databases. An example of a public database is the real estate database at the local county recorder office. An example of a private database is SiteXData® and DataQuick®. The information gathered at step 320 includes, but is not limited, to the user address, property type, fair market value of property, neighborhood sale statistics, the user date of birth, and social security number, etc.

As previously described, if the user social security cannot be found, CRM module 110 informs the loan officer to solicit user 120 for the information. CRM module 110 uses the social security number to obtain a credit report on the potential client. If user 120 refuses to provide the social security number, then user 120 is requested to estimate his or her credit ratings.

In step 330, CRM module 110 determines whether the user property is a rental unit or a residential unit. This may be done automatically by asking user 120 to answer a series of automated questions. Alternatively, this interview portion may be performed by the loan officer. If user 120 owns her current residence, then the process proceeds to step 340. Otherwise, the process proceeds to step 350.

In step 340, the user property fair market value is determined. This may be accomplished in several ways. The loan officer may make a best estimate of the property value by reviewing the neighborhood's sales statistic of similar properties. Alternatively, CRM module 110 may request for a third-party automated valuation model (AVM).

If the answer to step 330 is “yes”, then the process proceeds to step 350 as there is no property to evaluate. However, renters could still qualify for a first home mortgage or other types of loan based solely on income.

In step 350, CRM module 110 requests user 120 for her SSN and explicit permission to obtain her credit report from one or more of the three major credit bureaus. CRM module 110 may elect to use the lowest, highest, median, or average of the three credit scores obtained from the credit bureaus.

In step 360, CRM module 110 compiles all relevant data on user 120 into a data package and forwards the data package to one or more third-party pricing engines. The data package may include all data available on user 120 such as SSN, address, income, property value, etc.

In step 370, CRM module 110 retrieves and stores the pricing report on user 120 on CRM database 230. Using the pricing report, CRM module 110 determines the type of loans, amount, and rates user 120 is eligible for.

In step 380, CRM module 110 notifies user 120 of the results by email, text messaging, telephone, or other suitable communication modes. In step 390, CRM module 110 schedules a time to call the client or potential client back. When the scheduled time arrives, steps 310-380 is repated.

2.3 Human Resources and Accounting

In an embodiment of the invention, CRM module 110 includes a human resource and payroll/accounting module 270. Module 270 consolidates various HR and accounting functions such as: time-clocking, time-clock verification, pay-grade manipulation, commission calculations and verifications, performance monitoring, reviews, and recommendations. In this way, CRM module 110 may track the loan officer's hours, performance, reviews, and pay. CRM module 110 may also track the loan officer's, or other pertinent employees, medical, dental, vision benefits enrollment, program designation, coverage, company cost, monthly contribution, pay-period contribution, whole premium, 401 k enrollment documentation, contribution records, commitments, and associated contracts, any EDD records, notices, amounts paid, premium costs, and durations of receipt. Module 270 is hidden from the loan officer's view and may only be accessed with a high-level administration account. In an embodiment, CRM module 110 allows the high-level account owner (e.g., the loan officer's supervisor) to make certain portions of module 270 visible and/or accessible to the loan officer.

Module 270 may also provide the loan officer's supervisor or employer to store various documents pertaining to the loan officer's employment such as: hiring documents and agreements, employee hire sheet, equal employment opportunity data, acknowledgement of company policies, conflicts of interest agreement, equal employment opportunity agreement, protection of confidential information, loan assistant agreement, handbook receipt & acknowledgement, W-4, I-9, SFG pre-designation form, substance abuse policy, substance abuse policy agreement, cell phone use policy, worker's comp pre-designation, tuition reimbursement agreement, acknowledgement of sexual harassment training, direct deposit authorization, employee absence request forms, personal data change forms, harassment complaint procedure sheet, and notice of cobra rights sheet.

Module 270 provides the loan officer's supervisor with immediate access to the loan officer's records since everything is stored in CRM database 230. This helps facilitate the production and/or storage of any employee discipline and/or performance documents or records, including formal recommendations, improvement plans, reviews, reprimands, and any associated terms or agreements.

Module 270 also facilitates the production of documents pertaining to employee termination. In an embodiment, module 270 communicates with any benefits providers to inform them of the employee's employment status. In this way, the employee's benefits may be discontinued, modified, or started.

Module 270 is also configured to keep track of documents relating to the employee (e.g., the loan officer) that are in the possession of various benefits providers to determine whether or not they have been destroyed. In an embodiment, module 270 sends reminder to benefit providers to destroy all documents in their possession after a certain amount of time.

In another embodiment, module 270 monitors and notifies designated users or individuals regarding any changes or scheduled alerts regarding employment status of an employee, especially as pertaining to agreements with third-party staffing or temporary-employment companies or organizations. To facilitate this task, module 270 keep track of data such as terms of the employee's employment, expiration of contract periods, including those pertaining to direct-hire, payments made to third-party, and premium charged by third-party.

The term “tool” can be used to refer to any apparatus configured to perform a recited function. Tools can include a collection of one or more modules and can also be comprised of hardware, software or a combination thereof. Thus, for example, a tool can be a collection of software modules, hardware modules, software/hardware modules or any combination or permutation thereof. As another example, a tool can be a computing device or other appliance on which software runs or in which hardware is implemented.

While various embodiments of the present invention have been described above, it should be understood that they have been presented by way of example only, and not of limitation. Likewise, the various diagrams may depict an example architectural or other configuration for the invention, which is done to aid in understanding the features and functionality that can be included in the invention. The invention is not restricted to the illustrated example architectures or configurations, but the desired features can be implemented using a variety of alternative architectures and configurations. Indeed, it will be apparent to one of skill in the art how alternative functional, logical or physical partitioning and configurations can be implemented to implement the desired features of the present invention. Also, a multitude of different constituent module names other than those depicted herein can be applied to the various partitions. Additionally, with regard to flow diagrams, operational descriptions and method claims, the order in which the steps are presented herein shall not mandate that various embodiments be implemented to perform the recited functionality in the same order unless the context dictates otherwise.

Although the invention is described above in terms of various exemplary embodiments and implementations, it should be understood that the various features, aspects and functionality described in one or more of the individual embodiments are not limited in their applicability to the particular embodiment with which they are described, but instead can be applied, alone or in various combinations, to one or more of the other embodiments of the invention, whether or not such embodiments are described and whether or not such features are presented as being a part of a described embodiment. Thus the breadth and scope of the present invention should not be limited by any of the above-described exemplary embodiments.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof, the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

A group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise. Furthermore, although items, elements or components of the invention may be described or claimed in the singular, the plural is contemplated to be within the scope thereof unless limitation to the singular is explicitly stated.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other software or hardware components, can be combined in a single package or separately maintained and can further be distributed across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

1. A method for loan prospecting, comprising:
retrieving a telephone number of a potential client from a first database using a CRM module;
calling the retrieved telephone number to determine whether the potential client is interested in a financial product using a dialer embedded on a GUI of the CRM module;
retrieving personal data on the potential client from one or more external databases if the personal data is not available in the first database;
displaying the retrieved personal data on the GUI;
verifying the potential client's identity using the personal data;
obtaining a credit score on the potential client;
generating a loan pricing report using one or more pricing engines based on the credit score and the personal data; and
displaying the loan pricing report on the GUI.

2. The method of claim 1, further comprising:
scheduling and executing calls to specific clients; and
connecting them to a designated agent.

3. The method of claim 1, wherein the personal data includes one or more data from the list of address information, property type, value of property, social security number, and date of birth.

4. The method of claim 1, further comprising:
calculating a loan-to-value based on one or more data points of the personal data.

5. The method of claim 1, further comprising:
obtaining an automated valuation model from a third-party provider using one or more data points of the personal data.

6. The method of claim 1, prompting the potential client to enter the client's social security number if it is not available in the first database or the one or more external databases.

7. The method of claim 1, further comprising:
informing the potential client on a result of the pricing report via a telephone call, mobile text, or electronic mail.

8. The method of claim 1, wherein the one or more pricing engines are third-party pricing services.

9. The method of claim 1, wherein the credit score is obtained from one or more credit bureaus.

10. The method of claim 1, wherein the credit score is a median credit score among the credit scores from three different credit bureaus.

11. The method of claim 1, wherein a preferred time of contact is established by a user, and scheduled contacts are initiated instead of or in addition to regular campaign progressions.

12. A computer program product comprising a computer useable medium having computer readable program code functions embedded in the medium for causing a computer to test a circuit comprising:
a first computer readable program code that causes the computer to retrieve a telephone number of a potential client from a first database;
a second computer readable program code that causes the computer to call the retrieved telephone number to determine whether the potential client is interested in a financial product;
a third computer readable program code that causes the computer to retrieve personal data on the potential client from one or more external databases if the personal data is not available in the first database;
a fourth computer readable program code that causes the computer to verifying the potential client's identity using the personal data;
a fifth computer readable program code that causes the computer to obtain a credit score on the potential client;
a sixth computer readable program code that causes the computer to generate a loan pricing report using one or more pricing engines based on the credit score and the personal data.

13. The computer program product of claim 12 further comprising a seventh computer readable program code that causes the computer to recall a phone number scheduled for callback and execute a callback as part of campaign dialing.

14. The computer program product of claim 12, wherein the personal data includes one or more data from the group consisting of address information, property type, value of property, social security number, and date of birth.

15. The computer program product of claim 12, further comprising:
a seventh computer readable program code that causes the computer to calculate a loan-to-value based on one or more datum points of the personal data.

16. The computer program product of claim 12, further comprising:
a seventh computer readable program code that causes the computer to obtain an automated valuation model from a third-party provider using one or more data points of the personal data.

17. The computer program product of claim 12, further comprising:
an eighth computer readable program code that causes the computer to prompt the potential client to enter the client's social security number if it is not available in the first database or the one or more external databases.

18. The computer program product of claim 12, further comprising:
a ninth computer readable program code that causes the computer to inform the potential client on a result of the pricing report via a telephone call, mobile text, or electronic mail.

19. The computer program product of claim 12, wherein the one or more pricing engines are third-party pricing services.

20. The computer program product of claim 12, wherein the credit score is obtained from one or more credit bureaus.

21. The computer program product of claim 19, wherein the credit score is a median credit score among the credit scores from three different credit bureaus.

22. The method of claim 1, further comprising:
locking a loan product using data from the loan pricing report, wherein locking the loan product includes locking one or more variables from the group consisting of a loan type, a loan amount, rate, price, and rebate; and
storing the locked loan product along with identification data of the potential client.

23. The method of claim 22, wherein the variables can be adjusted by the potential client.

24. The computer program product of claim 20, further comprising a computer readable code that causes the computer to automatically query to the third-party pricing database at various time intervals.

25. The computer program product of claim 24, further comprising a computer readable code that compares the pricing results returned by the query with a desired set of pricing criteria.

26. The computer program product of claim 25, further comprising a computer readable code which causes the computer to verify that the comparison meets a set of predefined criteria.

27. The computer program product of claim 26, further comprising a computer readable code which causes the computer to lock the loan based on the verification.
